(19) United States
(12) Patent Application Publication
(10) Pub. No.: US 2026/0108844 A1
(43) Pub. Date: Apr. 23, 2026

(54) HIGH SURFACE AREA SORBENT FORM FACTORS FOR FAST CO2 UPTAKE

(71) Applicants: Thiago BARBOSA, Tempe, AZ (US); Klaus LACKNER, Longmont, CO (US); Samantha TAYLOR, Tempe, AZ (US)

(72) Inventors: Thiago BARBOSA, Tempe, AZ (US); Klaus LACKNER, Longmont, CO (US); Samantha TAYLOR, Tempe, AZ (US)

(73) Assignee: Arizona Board of Regents on Behalf of Arizona State University, Scottsdale, AZ (US)

(21) Appl. No.: 19/366,406

(22) Filed: Oct. 22, 2025

Related U.S. Application Data
(60) Provisional application No. 63/710,336, filed on Oct. 22, 2024.

(51) Int. Cl. B01D 53/14; B01D 53/62; B01D 53/96

(52) U.S. Cl. CPC B01D 53/1475; B01D 53/62; B01D 53/96; B01D 2252/204; B01D 2257/504

(57) ABSTRACT

Embodiments of the present disclosure relate to sorbent units designed for efficient direct air capture of carbon dioxide. A sorbent material is contained within an enclosure that is pervious to airflow, enabling passive or active exposure to ambient air. The enclosure is sized and shaped so that the ratio of its surface area to the mass of the sorbent material meets or exceeds a threshold value, such as 90 cm² per gram, and in some embodiments, may be much higher. This high surface area-to-mass ratio facilitates rapid CO₂ uptake, even at low wind velocities. The enclosure may take the form of a pervious bag or be divided into multiple partitions, such as tubes or other geometric shapes, and is typically constructed from polymer mesh with pores sized to retain the sorbent particles. The sorbent material may be a porous resin, often in bead form, and may be functionalized with amines to enhance CO₂ capture. These form factors are adaptable to a range of sorbent materials and operating conditions, improving the efficiency and scalability of direct air capture systems.

### RELATED APPLICATIONS

This application claims the benefit of U.S. provisional patent application 63/710,336, filed Oct. 22, 2024, titled “High Surface Area Sorbent Form Factors for Fast CO2 Uptake,” the entirety of the disclosure of which is hereby incorporated by this reference.

### TECHNICAL FIELD

Aspects of this document relate generally to carbon dioxide capture with sorbent materials.

### BACKGROUND

The need for technologies to remove carbon dioxide from ambient air is well established. Atmospheric CO₂ concentration reached approximately 415 ppm in June 2021, contributing to elevated global temperatures, extreme weather, and widespread wildfires. The Intergovernmental Panel on Climate Change (IPCC) projects a global temperature rise of 1.5° C. within two decades, even with aggressive emission reductions. Without such intervention, average temperatures could rise by up to 4.4° C., leading to severe environmental and societal impacts. Current emissions are approximately 40 gigatons (GT) CO₂ per year.

Alongside conservation, reduced-carbon processes, and point-source capture, large-scale removal of atmospheric CO₂ is required to mitigate climate change. Estimates indicate that about 1,000 GT CO₂ must be removed by the end of the century to limit warming to below 2° C. relative to preindustrial levels.

Passive direct air capture (passive DAC) is a promising approach for extracting dilute atmospheric CO₂ efficiently. Unlike active DAC systems, which require energy for forced air movement, passive DAC relies on natural airflows across contactor surfaces containing CO₂-sorbent materials. The captured CO₂ is later released for processing, utilization, or storage.

A variety of sorbent materials can be used for CO₂ uptake; however, many exhibit mechanical or environmental sensitivities that hinder their use in structured geometries. Some are too brittle to form extended or sheet-like bodies, while others deform under thermal or moisture swings, introducing stress that limits dimensional stability. These issues are especially pronounced for materials operating under thermal- or moisture-swing cycles.

Although certain materials exhibit favorable sorbent characteristics, they require structural support to maintain exposure to airflow and prevent entrainment or loss during operation. Many are only available as powders, beads, or pellets, necessitating containment systems that retain the sorbent while allowing sufficient air contact. Maintaining high CO₂ absorption rates under low wind velocities is essential for minimizing energy costs and enabling effective passive capture using ambient airflows.

### SUMMARY

According to some embodiments, a sorbent unit for direct air capture of carbon dioxide includes a sorbent material and an enclosure. The sorbent material has a mass, and the enclosure contains the sorbent material while allowing air to flow through. The enclosure is sized and shaped so that the ratio of its surface area to the mass of the sorbent material is at least 90 cm² per gram, and in some cases, this ratio may be much higher, such as 2,000 cm² per gram.

Embodiments of the present disclosure may feature enclosures that are pervious bags, or that are divided into multiple partitions—such as tubes, squares, or hexagons—with partitions optionally sharing the same cross-sectional shape. The enclosure is typically made of a polymer mesh and may have pores smaller than 300 microns to retain the sorbent particles.

The sorbent material itself may be a porous resin, often in bead form, and may be functionalized with amines to enhance CO₂ capture. In some embodiments, the sorbent is designed for temperature-swing operation, absorbing CO₂ at lower temperatures and releasing it at higher temperatures.

The threshold surface area-to-mass ratio can be tailored based on the properties of the sorbent, such as its uptake rate or particle size distribution. Overall, these embodiments allow for a range of enclosure designs, sorbent materials, and operating conditions, all aimed at improving the efficiency and adaptability of direct air capture systems. The threshold surface area-to-mass ratio can be tailored based on the properties of the sorbent, such as its uptake rate or particle size distribution. The disclosure covers a range of possible variations in enclosure design, sorbent material, and operating conditions, all aimed at improving the efficiency and adaptability of direct air capture systems. Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIGS. 1A and 1B are front and cross-sectional views of a fast uptake sorbent unit, respectively;

FIGS. 2A and 2B are front and cross-sectional views of a fast uptake sorbent unit that is partitioned into tubes, respectively;

FIGS. 3A and 3B are front views of fast uptake sorbent units with partitions having square and hexagonal cross-sectional shapes, respectively;

FIGS. 4-6 show comparisons of CO₂ absorption for different sorbents, some having been loaded into a specific example of a fast uptake sorbent unit; and

FIG. 7 shows a comparison of the ratio of surface area to sorbent mass for various form factors and sorbent materials.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The need for technologies to remove carbon dioxide from ambient air has been well established. The average CO₂ concentration in the atmosphere was 415 ppm in June 2021, which has been linked to elevated average global temperatures, extreme weather, wildfires, and more. The Intergovernmental Panel on Climate Change's 2021 report predicts a 1.5° C. rise in global temperature within the next two decades, assuming global policymakers aggressively reduce emissions. Without intervention, an average temperature rise of 4.4° C. is possible, leading to catastrophic results. Current CO₂ emissions are projected to reach 40 GT CO₂/year.

In addition to conservation, reduced-carbon processes, and on-site capture efforts, a significant amount of carbon dioxide will need to be removed from the atmosphere to avoid a looming climate change crisis. It is estimated that about 1,000 GT of CO₂ from the atmosphere needs to be removed by the end of the century in order to keep Earth below 2° C. of warming compared to before the Industrial Revolution.

A promising technology that is well adapted for capturing dilute atmospheric carbon dioxide in an energy efficient manner is passive direct air capture (hereinafter “passive DAC”) which is distinguished from other DAC technologies which require additional energy for the forced convection of air. Air contactor surfaces that comprise sorbent materials are exposed to passive atmospheric air flows, capturing carbon dioxide with the sorbent material to be released within an appropriate context for further processing, use, and/or storage.

There is a diverse range of sorbent materials that can be used for the uptake of CO₂ or other substances. However, many of these materials have physical properties that make it impossible or impractical to shape them into linear or sheet-like structures. For example, in many cases, the material is too brittle to be shaped in such a fashion. In some cases, the material experiences a substantial change in shape when exposed to moisture and/or heat, creating stresses that limit all dimensions to a short scale. This is particularly problematic for materials that operate on a moisture- or thermal-swing, and are repeatedly exposed to these stresses in the course of normal operation.

Some of these materials have excellent sorbent characteristics but need some structural support to be exposed to airflow without getting entrained in the gas stream or dropped from the contactor during operation. Many of these materials can only be produced as fine powders, beads, or pellets. These sorbents have to be contained in a manner that prevents loss of sorbent without inhibiting their exposure to passive air flow. The CO₂ absorption rate for sorbents can significantly decline with wind velocity; maintaining a high CO₂ absorption rate at low wind velocities is critical to reduce costs for moving air through a DAC sorbent collector or to enable feasible CO₂ absorption rates when the air is delivered passively by natural wind flows.

Contemplated herein is a sorbent unit having a high surface area form factor for fast CO₂ absorption uptake. According to various embodiments, the contemplated fast uptake sorbent units have form factors that are shaped to have a high surface area, and are sized to hold an amount of sorbent material such that the ratio of enclosure surface area to sorbent mass is greater than a threshold ratio (e.g., 90 cm²/g). Sorbent units having a surface area to mass ratio above this threshold advantageously allow the solid sorbent to behave as individual particles, rather than a packed solid. This results in greatly enhanced air contact, which directly influences the absorption uptake rate, improving CO₂ sorption from sources as diluted as atmospheric CO₂, where the CO₂ concentration is only about 420 ppm or 42 Pa at sea level. Having a fast uptake rate means the capture/release cycle time of the DAC will be shortened, yielding an overall higher CO₂ uptake over time, according to various embodiments. For a passive direct air capture (PDAC) application, the effect of wind velocity is minimized, keeping the high CO₂ uptake at the low and higher wind velocities.

It should be noted that while much of this disclosure is done in the context of passive direct air capture, other embodiments of the contemplated fast uptake sorbent units may be implemented in other types of capture devices, such as forced air DAC systems, including those operating at a low air flow rate. Additionally, the sorbent units contemplated herein may also be used to capture CO₂ from sources other than the atmosphere, such as industrial exhaust and other point sources.

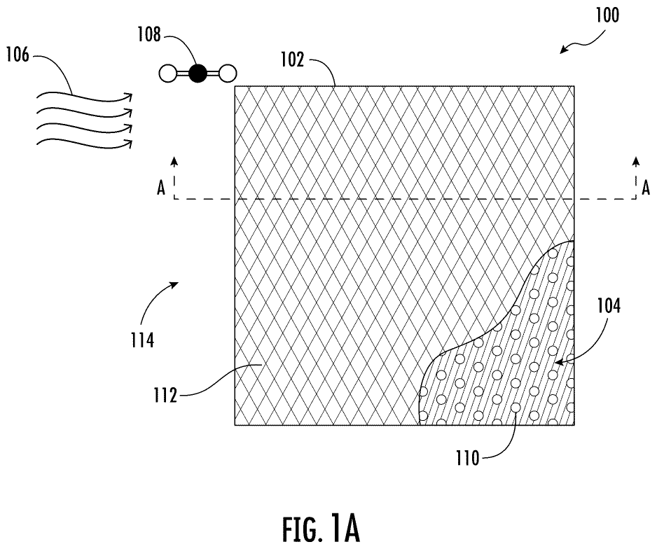

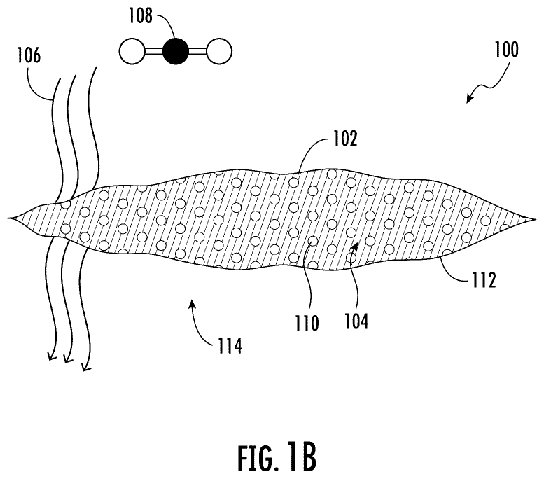

FIGS. 1A and 1B are various views of a non-limiting example of a fast uptake sorbent unit 100. Specifically, FIG. 1A shows a front view of the sorbent unit 100 with a portion of the enclosure 102 cut away, and FIG. 1B shows a cross-sectional view taken at the line A-A of FIG. 1A. In the context of the present description and the claims that follow, a sorbent unit 100 is a sorbent material 104 that is enveloped or otherwise contained inside an enclosure 102 that is configured to both retain the sorbent material 104 while also permitting exposure to air flow 106 (i.e., the enclosure 102 is pervious to air flow 106). As previously mentioned, some of the best performing sorbent materials 104 have physical properties that limit their practical (e.g., scalable) implementation to particular forms including, but not limited to, powders, beads (e.g., the beads 110 of FIGS. 1A and 1B), and the like. Organizing these particulate sorbent materials 104 into sorbent units 100 facilitates their use in passive direct air capture devices and systems.

The enclosure 102 of the non-limiting example of a sorbent unit 100 shown in FIGS. 1A and 1B is a pervious bag 114 containing sorbent beads 110. According to various embodiments, the enclosure 102 is sized and shaped to have a surface area such that a ratio of the surface area to the mass of the sorbent material 104 is greater than a threshold ratio. In some embodiments, the threshold ratio is based upon at least one of an uptake rate of a single particle of the sorbent material 104 and a size distribution of particles of the sorbent material 104. As will be discussed in greater detail below, in some embodiments the threshold ratio may be at least 90 cm²/g, while in other embodiments the threshold ratio may be at least 2000 cm²/g.

The threshold ratio can be exceeded using various form factors. In the context of the present description and the claims that follow, a “form factor” is a definition of some physical attribute of the sorbent unit 100. Specifically, the form factor of a sorbent unit 100 may define, or constrain, the physical size, shape, configuration, materials, weight, and/or distribution of sorbent materials 104. It should be noted that a form factor, as used herein, need not define or constrain all of these attributes. Some form factors may be agnostic with respect to some of these attributes while defining or constraining (e.g., setting a floor, setting a ceiling, etc.) others.

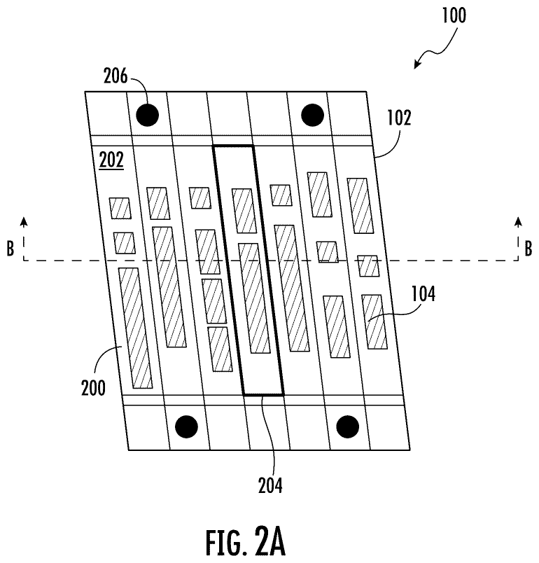

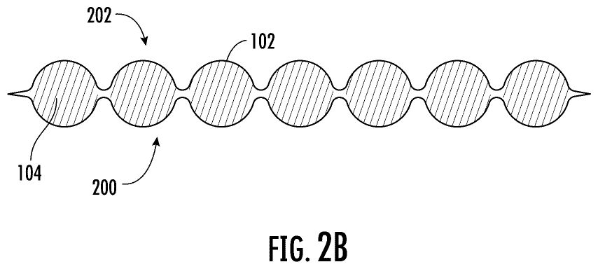

It is important to note that when speaking of the surface area to sorbent mass ratio, the surface area being referred to is the surface area of a pervious material that makes up the enclosure 102. In the context of the present description and the claims that follow, a pervious material is a material that allows an air flow 106 (e.g., wind, forced air, etc.) to pass through it due to the presence of pores, openings, or inherent permeability. The specific, non-limiting examples shown in FIGS. 1A-2B comprise polymer mesh 112 (e.g., nylon mesh, etc.) as a pervious material. Other examples of pervious materials include, but are not limited to, materials that are reticulated or mesh, porous, perforated, ventilated, permeable, breathable weaves, aerated, and the like.

In addition to allowing an air flow 106 to pass through, the pervious material is also chosen to be compatible with the sorbent material 104 or, more specifically, compatible with the regeneration process used for the sorbent material 104. The enclosure 102 is made from a pervious material that can withstand the range of temperatures, moisture levels, and/or pressure levels experienced by the sorbent material 104 as it moves through the cycle of absorption and desorption.

According to various embodiments, the contemplated fast uptake sorbent unit 100 has a form factor that is only constrained in the pervious surface area to sorbent mass ratio, and is not limited to any particular geometry so long as this ratio exceeds the threshold. This opens up a wide range of geometries, advantageously allowing the contemplated sorbent unit 100 to be adapted for use on various DAC device architectures and with a variety of sorbent materials 104.

For example, in some embodiments the enclosure 102 may be simple, like the pervious bag 114 of FIGS. 1A and 1B. These may present certain advantages, such as simple and less expensive manufacture. In other embodiments, the enclosure 102 may be divided up into various partitions, keeping the sorbent material 104 separated into groups.

FIGS. 2A and 2B are various views of a non-limiting example of a fast uptake sorbent unit 100 that is partitioned into pervious tubes 200. Specifically, FIG. 2A shows a front view of the sorbent unit 100 and FIG. 2B shows a cross-sectional view along BB. As previously mentioned, in some embodiments the enclosure 102 of a sorbent unit 100 may be partitioned such that the sorbent material 104 of the sorbent unit 100 is separated into groups, effectively spreading it out across the enclosure 102. In some embodiments, each partition 202 may comprise some of the sorbent material 104 while in other embodiments, some partitions 202 may be empty.

Sorbent units 100 may be adapted for use with a variety of DAC devices. For example, the non-limiting example shown in FIG. 2A comprises four fasteners 206 that may be used to couple the sorbent unit 100 to a movable framework within a passive DAC device. Those skilled in the art will recognize that any other fastener known in the art may be adapted for use in securing a sorbent unit 100 to a DAC device.

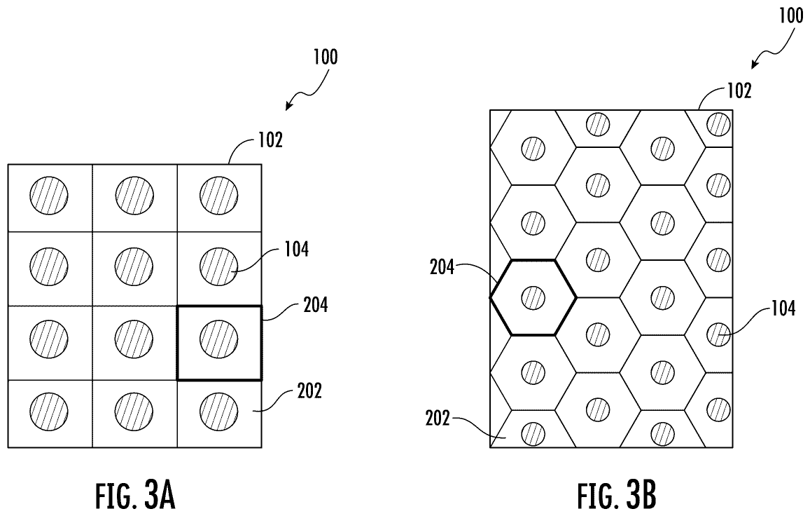

Each of the partitions 202 of the sorbent unit 100 has a cross-sectional shape 204 (i.e., the shape of the partition 202 when viewed from the front). The pervious tubes 200 of FIGS. 2A and 2B have an elongated rectangular cross-sectional shape 204. FIGS. 3A and 3B are front views of fast uptake sorbent units 100 with partitions 202 having square and hexagonal cross-sectional shapes 204, respectively. In some embodiments, a variety of partition 202 shapes may be used, while in other embodiments each partition 202 of the sorbent unit 100 may have the same cross-sectional shape 204.

It should also be noted that while the non-limiting examples shown in FIGS. 1A-3B have had enclosures 102 that are entirely pervious material, in other embodiments the enclosure 102 may comprise pervious “windows” or regions that allow the passage of air flow 106. As a specific example, in one embodiment the enclosure 102 of a sorbent unit 100 may be a rigid shell comprising a plurality of pervious windows sized such that the ratio of the surface area of these windows to mass of the enclosed sorbent material 104 is at least equal to a threshold ratio (e.g., 90 cm²/g).

Improved air contact is beneficial to any sorbent material 104. Although all of the specific examples discussed herein make use of thermal swing materials, those skilled in the art will recognize that the contemplated form factor may be adapted for use with other types of sorbent materials 104 (e.g., moisture-swing, pressure-swing, etc.). However, although the contemplated form factor would benefit the air contact of any particulate-style sorbent material 104, the materials used in the sorbent unit 100 (particularly the pervious material) will need to be compatible with whatever method is used for regenerating the sorbent (e.g., liquid water, steam, vacuum, heat, etc.).

The following is a discussion of a number of specific, non-limiting examples and their observed properties. The sorbents utilized in the specific, non-limiting examples discussed below are thermal swing sorbents, cycling the temperature between ambient (−20 to 50° C.) for the absorption phase and temperatures ranging from 70 to 100° C. for the desorption/regeneration phase as part of temperature and temperature-vacuum systems. Specifically, these sorbents consist of a highly porous amine functionalized structure, and are commercially available in bead form (i.e., Mitsubishi Diaion CR20, Purolite A110, and Sunrise CT20). It should be noted that other sorbent materials 104 may absorb and regenerate within temperature ranges different from those of this specific example, as is known in the art

All three of these sorbent materials 104 absorb CO₂ at ambient temperatures (i.e.,-20 to 50° C.) and desorb at higher temperatures (i.e., 70-100° C.). Diaion CR20 is a chelating resin with a polyamine functionalized group within a highly porous styrene-divinylbenzene matrix. Purolite A110 consists of a primary amine functionalized group that also has a highly porous styrene-divinylbenzene matrix. CT 20 is a porous bead crosslinked with polystyrene functionalized with primary amines.

The sorbents were loaded into three form factors: a hexagonal packed bed frame with a surface area to sorbent weight ratio of 7.1 cm²/g, elongated mesh tubes 200 (FIGS. 2A and 2B) with a ratio of 96.5 cm²/g, and a squared polyester pervious bag 114 (FIGS. 1A and 1B) with a ratio >2,000 cm²/g. In this specific case, the hexagonal packed bed frame is being used for comparison purposes, and does not represent an embodiment of the contemplated sorbent unit 100 because the pervious surface area to sorbent mass ratio is below the threshold.

In each of these specific examples, each sample was incubated in an oven at 80° C., along with a 1 L beaker containing 500 mL of DI H₂O, for 7 hours in order to desorb CO₂ at the maximum possible rate in fixed environmental conditions, at a fixed temperature, and at a relative humidity of roughly 100%.

The hexagonal packed bed frame and elongated mesh tube 200 form factors were also characterized in a wind tunnel. Each sample was transferred to a 561 L wind tunnel sample chamber to measure CO₂ absorption kinetics. The wind tunnel was set at a fixed temperature (i.e., 25° C.), relative humidity (i.e., 5%), and a wind velocity of either 6 m/s or 1 m/s. Carbon dioxide 108 absorption was measured for 10,000 s (i.e., 2.8 hours), and the CO₂ absorption of the sorbent in each form factor was compared at the two distinct wind velocities.

The squared pervious bag 114 samples were characterized in a small-scale closed system device with a total of 243 mL of air. The sample was first regenerated with the same method used in the wind tunnel experiments. Then the sample was immediately exposed in a closed system device at 23° C., 42-48 Pa initial CO₂ partial pressure, and 18-80% RH.

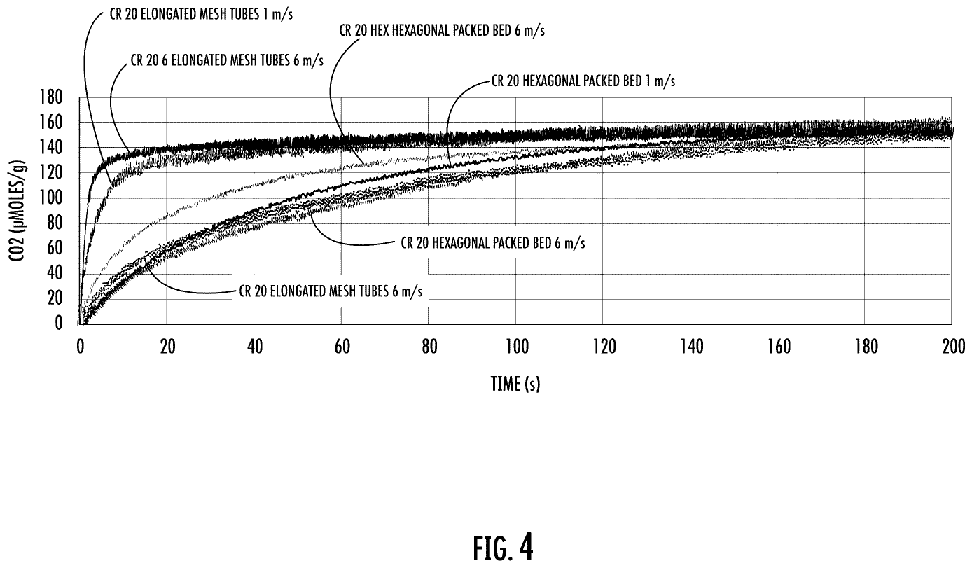

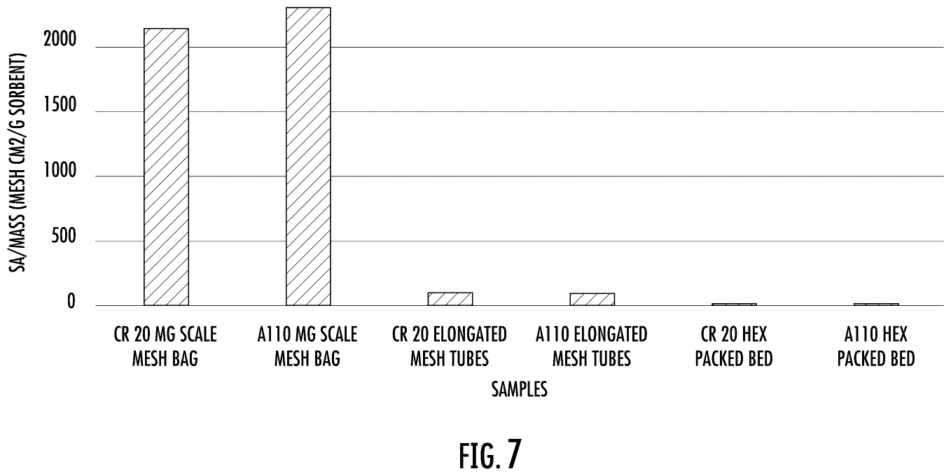

FIGS. 4-7 show the results of the measurements performed on the specific embodiments discussed above. Specifically, FIGS. 4-6 show comparisons of CO₂ absorption, and FIG. 7 shows a comparison of the ratio of surface area to sorbent mass, for various form factors and sorbent materials. The sorbent unit 100 that were characterized have 3 distinct form factors: A) individual sorbent particles in a squared pervious bag 114 (also referred to as mg-scale individual beads 110), B) elongated mesh tubes 200, and C) a hexagonal packed bed. The surface area to sorbent mass ratio of each form factor is 2,143-2,300, 96.5 and 7.1 cm²/g, respectively. See Table 1 and FIG. 7.

TABLE 1

| | | | | | CR 20 | A110 |
|---|---|---|---|---|---|---|
| | CR 20 mg | A110 mg | CR 20 | A110 | Hex | Hex |
| | scale mesh | scale mesh | Elongated | Elongated | packed | packed |
| Sample | bag | bag | mesh tubes | mesh tubes | bed | bed |
| sorbent weight (g) | 0.0042 | 0.0039 | 6 | 6 | 13.7 | 13.7 |
| polyester mesh weight | 0.1434 | 0.1115 | 1.8068 | 1.7546 | 0.8067 | 0.8418 |
| SA/mass (mesh cm²/g | 2143 | 2308 | 96.5 | 96.5 | 7.1 | 7.1 |
| sorbent) | | | | | | |

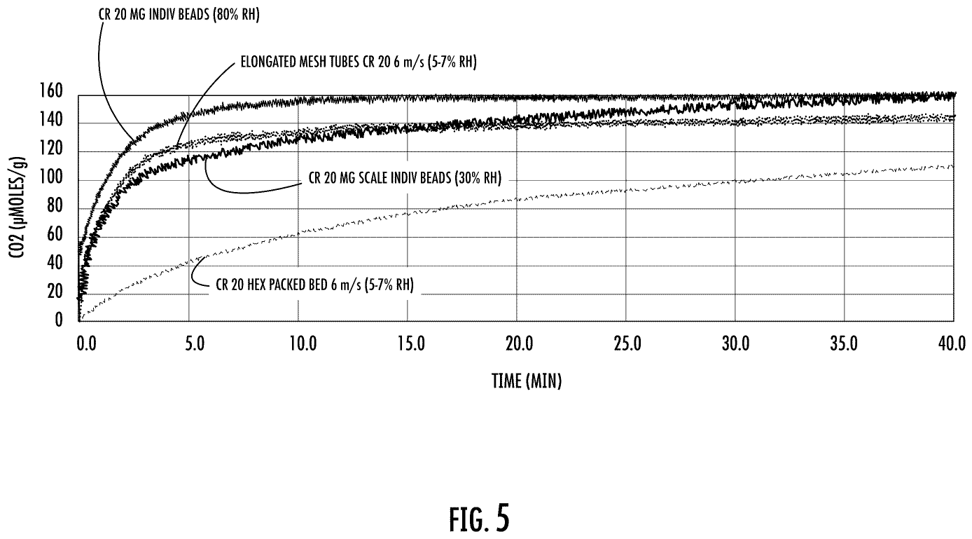

FIG. 4 is a comparison of the CO₂ absorption for the sorbents CR20 and CT20 when loaded within elongated mesh tubes 200, compared with a hexagonal packed bed at 1 and 6 m/s wind velocities. FIG. 5 shows a similar comparison, but between elongated mesh tubes 200 and mg-scale individual sorbent beads 110.

As shown, the CO₂ uptake rate increased significantly when the surface area increased by one order of magnitude, comparing form factors B and C. The form factor A increases one order of magnitude from form factor B and 2 orders of magnitude from form factor C. It is possible to observe in FIGS. 4 and 5 that the performance is maintained the same when comparing form factors A and B. This indicates that form factor B was already behaving in an optimum air to contact with the sorbent, as the particles can behave individually. This also demonstrates that the sorbent can maintain a high uptake rate independently of the geometric configuration, such as tubes 200, squares, rounds, hexagons, etc., As long as the high surface area to sorbent mass polyester mesh containment is maintained.

As shown in FIG. 4, Diaion CR20 contained within elongated mesh tubes 200 (form factor B) loads to 100 μmoles CO₂/g 14.1-fold faster at 6 m/s than when loaded in a hexagonal packed bed (form factor C) and loads to 70% of its capacity within 2 or 6 minutes at 6 and 1 m/s respectively, which is significantly faster than many other temperature vacuum swing sorbents that can take between 30 minutes and 2 hours to load.

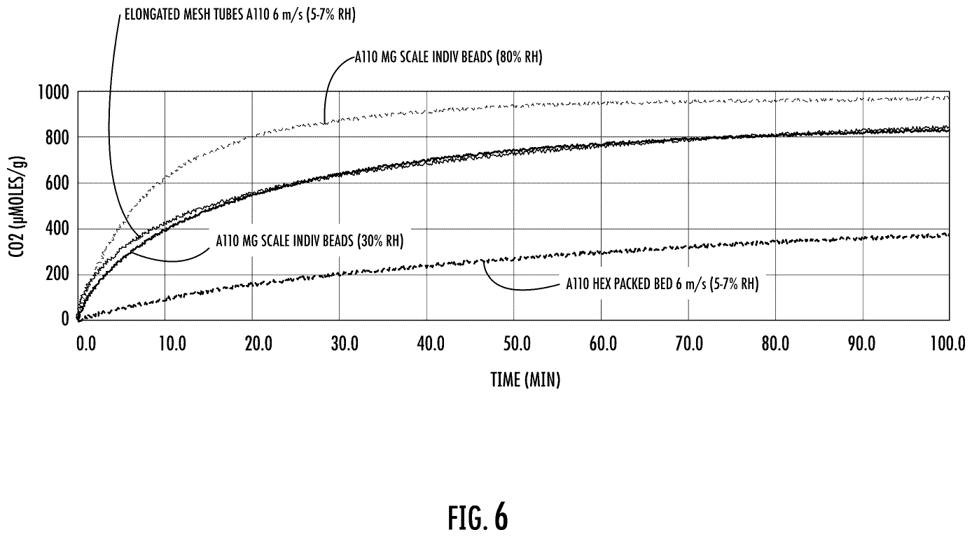

As shown in FIG. 6, the sorbent A110 also obtained a significant CO₂ uptake rate. Considering the time to uptake 300 μmol CO₂/g, the elongated mesh tubes 200 loaded about 12.8-fold faster than the hexagonal pecked bed form factor. However, the sorbent CT20 obtained the same performance in both form factors and thus did not have a benefit from the higher surface area to sorbent mass ratio. This shows that the combination of the highly porous styrene-divinylbenzene sorbent matrix and the surface area ratio of pervious containment is effective in obtaining a very fast CO₂ uptake rate.

It should be noted that the threshold surface area to mass ratio is primarily a function of the properties of the sorbent. The faster the uptake rate of a single sorbent particle, the larger the surface to mass ratio must be. The enclosure 102 is also limited by the nature of the sorbent material 104. According to various embodiments, the enclosure 102 is pervious, with pores, apertures, etc. that are large enough to allow air flow 106 to pass through, yet small enough to contain the sorbent material 104 within.

Additionally, the sorbent particles (e.g., beads 110, grains, etc.) typically have a size distribution. For example, in one specific embodiment the sorbent beads 110 have a size distribution that ranges from 300 to 1200 microns. An enclosure 102 with pores or perforations smaller than 300 microns would be needed to retain the entire range of bead sizes. All of these factors can influence the threshold surface area to mass ratio. The 90 cm²/g is an empirical number that fits well with currently available materials; consideration of these particular properties may yield a different threshold value more tailored to a particular sorbent material 104 having a particular form, according to some embodiments.

It will be understood that implementations of the fast CO₂ uptake sorbent unit 100 form factor include but are not limited to the specific components disclosed herein, as virtually any components consistent with the intended operation of various sorbent unit 100 form factors may be utilized. Accordingly, for example, it should be understood that, while the drawings and accompanying text show and describe particular fast CO₂ uptake sorbent unit 100 form factor implementations, any such implementation may comprise any shape, size, style, type, model, version, class, grade, measurement, concentration, material, weight, quantity, and/or the like consistent with the intended operation of a sorbent unit 100.

The concepts disclosed herein are not limited to the specific fast CO₂ uptake sorbent unit 100 shown herein. For example, it is specifically contemplated that the components included in particular fast CO₂ uptake sorbent units 100 may be formed of any of many different types of materials or combinations that can readily be formed into shaped objects and that are consistent with the intended operation of the sorbent unit 100. For example, the components may be formed of: rubbers (synthetic and/or natural) and/or other like materials; glasses (such as fiberglass), carbon-fiber, aramid-fiber, any combination thereof, and/or other like materials; elastomers and/or other like materials; polymers such as thermoplastics (e.g., ABS, fluoropolymers, polyacetal, polyamide, polycarbonate, polyethylene, polysulfone, and/or the like), thermosets (e.g., epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, fast CO₂ uptake sorbent units 100 may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

It will be understood that implementations are not limited to the specific components disclosed herein, as virtually any components consistent with the intended operation of a fast uptake sorbent unit having a high surface area form factor may be utilized. Accordingly, for example, although particular systems, methods, and/or devices for sorbent materials and pervious enclosures may be disclosed, such components may comprise any shape, size, style, type, model, version, class, grade, measurement, concentration, material, weight, quantity, and/or the like consistent with the intended operation of a fast uptake sorbent unit having a high surface area form factor may be used. In places where the description above refers to particular implementations of a fast uptake sorbent unit having a high surface area form factor, it should be readily apparent that a number of modifications may be made without departing from the spirit thereof and that these implementations may be applied to other direct capture technologies, passive or otherwise.

What is claimed is:

1. A sorbent unit for direct air capture of carbon dioxide, comprising:
a sorbent material having a mass;
an enclosure containing the sorbent material, the enclosure being pervious to an air flow;
wherein the enclosure is sized and shaped to have a surface area such that a ratio of the surface area to the mass of the sorbent material is at least 90 cm²/g.

2. The sorbent unit of claim 1, wherein the enclosure is a pervious bag.

3. The sorbent unit of claim 1, wherein the enclosure is divided into a plurality of partitions, each partition containing sorbent material.

4. The sorbent unit of claim 3, wherein each partition of the plurality of partitions comprises the same cross-sectional shape.

5. The sorbent unit of claim 3, wherein each partition is a pervious tube.

6. The sorbent unit of claim 1, wherein the sorbent material is a temperature-swing sorbent material that absorbs CO₂ at −20° C. to 50° C. and desorbs CO₂ at 70° C. to 100° C.

7. The sorbent unit of claim 1, wherein the ratio is at least 2000 cm²/g.

8. The sorbent unit of claim 1, wherein the sorbent material is a porous resin.

9. The sorbent unit of claim 1, wherein the sorbent material is in the form of beads.

10. The sorbent unit of claim 9, wherein the sorbent material comprises amine-functionalized porous polymer beads.

11. The sorbent unit of claim 1, wherein the enclosure is composed of a polymer mesh.

12. The sorbent unit of claim 1, wherein the enclosure comprises pores smaller than 300 microns.

13. A sorbent unit for direct air capture of carbon dioxide, comprising:
a sorbent material that is particulate and has a mass;
an enclosure containing the sorbent material, the enclosure being pervious to an air flow;
wherein the enclosure is sized and shaped to have a surface area such that a ratio of the surface area to the mass of the sorbent material is greater than a threshold ratio based upon at least one of an uptake rate of a single particle of the sorbent material and a size distribution of particles of the sorbent material.

14. The sorbent unit of claim 13, wherein the threshold ratio is at least 90 cm²/g.

15. The sorbent unit of claim 13, wherein the enclosure is a pervious bag.

16. The sorbent unit of claim 13, wherein the enclosure is divided into a plurality of partitions, each partition containing sorbent material.

17. The sorbent unit of claim 16, wherein each partition is a pervious tube.

18. The sorbent unit of claim 13, wherein the threshold ratio is at least 2000 cm²/g.

19. The sorbent unit of claim 13, wherein the sorbent material comprises amine-functionalized porous polymer beads.

20. The sorbent unit of claim 13, wherein the enclosure is composed of a polymer mesh.
